(19) United States
(12) Patent Application Publication
(10) Pub. No.: US 2023/0068874 A1
(43) Pub. Date: Mar. 2, 2023

(54) OPTIMAL LEARNING RATE SELECTION THROUGH STEP SAMPLING

(71) Applicant: SAMSUNG ELECTRONICS CO., LTD., Suwon-si (KR)

(72) Inventors: Suhel JABER, San Jose, CA (US); Brendon C. EBY, Chicago, IL (US)

(73) Assignee: SAMSUNG ELECTRONICS CO., LTD., Suwon-si (KR)

(21) Appl. No.: 17/695,064

(22) Filed: Mar. 15, 2022

Related U.S. Application Data
(60) Provisional application No. 63/239,329, filed on Aug. 31, 2021.

(51) Int. Cl. G06N 20/00

(52) U.S. Cl. CPC G06N 20/00

(57) ABSTRACT

A method of training a model includes selecting a learning rate for the model, training the model based on the learning rate, determining a derivative of a loss for an objective function for the model with respect to the learning rate based on a result of the training, and based on the derivative of the loss being greater than a predetermined derivative threshold, determining at least one point of interest based on the result of the training, selecting a subsequent learning rate based on the at least one point of interest, training the model based on the subsequent learning rate, and selecting an optimal learning rate based on the training results.

### CROSS-REFERENCE TO RELATED APPLICATION(S)

This application is based on and claims priority under 35 U.S.C. § 119 to U.S. Provisional Application No. 63/239,329, filed on Aug. 31, 2021, the disclosure of which is incorporated herein by reference in its entirety.

### BACKGROUND

### 1. Field

The disclosure relates to systems and methods for selecting learning rates for machine-learning models.

### 2. Description of Related Art

Machine learning models operate based on a selection of hyper-parameters, which are variables that define the way in which the model can learn. However, the hyper-parameters cannot be learned by the model itself and instead are assigned in advance. One hyper-parameter is the learning rate of the model, which may be a step size that the model uses when learning its parameters. The learning rate of the model is typically selected by trial and error or from guesses based on prior knowledge, which is imprecise and requires a large amount of time to optimize.

### SUMMARY

In accordance with an aspect of the disclosure, a method of training a model may include selecting a learning rate for the model, training the model based on the learning rate, determining a derivative of a loss for an objective function for the model with respect to the learning rate based on a result of the training, and based on the derivative of the loss being greater than a predetermined derivative threshold, determining at least one point of interest based on the result of the training, selecting a subsequent learning rate based on the at least one point of interest, training the model based on the subsequent learning rate, and selecting an optimal learning rate based on the training results.

In accordance with an aspect of the disclosure, a system for training a model may include a processor, and a memory storing instructions that, when executed, cause the processor to select a learning rate for the model, train the model based on the learning rate, determine a derivative of a loss for an objective function for the model with respect to the learning rate based on a result of the training, and based on the derivative of the loss being greater than a predetermined derivative threshold, determine at least one point of interest based on the result of the training, select a subsequent learning rate based on the at least one point of interest, train the model based on the subsequent learning rate, and select an optimal learning rate based on the training results.

In accordance with an aspect of the disclosure, a non-transitory computer-readable storage medium may include instructions that, when executed, cause at least one processor to select a learning rate for the model, train the model based on the learning rate, determine a derivative of a loss for an objective function for the model with respect to the learning rate based on a result of the training, and based on the derivative of the loss being greater than a predetermined derivative threshold, determine at least one point of interest based on the result of the training, select a subsequent learning rate based on the at least one point of interest, train the model based on the subsequent learning rate, and select an optimal learning rate based on the training results.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of devices of a system according to an embodiment;

FIG. 2 is a diagram of components of the devices of FIG. 1 according to an embodiment;

FIG. 3 is a diagram of a training pipeline, according to an embodiment;

FIG. 4 is a flowchart of a method of a grid search process, according to an embodiment;

FIG. 5 is a flowchart of a method of a refinement process, according to an embodiment;

FIG. 6 is a flowchart of a method of selecting a learning rate, according to an embodiment;

FIGS. 7A and 7B are graphs showing selection of a learning rate, according to an embodiment;

FIG. 8 is a flowchart of a method of selecting a learning rate, according to an embodiment;

FIG. 9 is a graph showing selection of a learning rate, according to an embodiment;

FIG. 10 is a flowchart of a method of selecting a learning rate, according to an embodiment;

FIGS. 11A and 11B are graphs showing selection of a learning rate, according to an embodiment; and

FIG. 12 is a flowchart of a method of selecting a learning rate, according to an embodiment.

### DETAILED DESCRIPTION

The following detailed description of example embodiments refers to the accompanying drawings. The same reference numbers in different drawings may identify the same or similar elements.

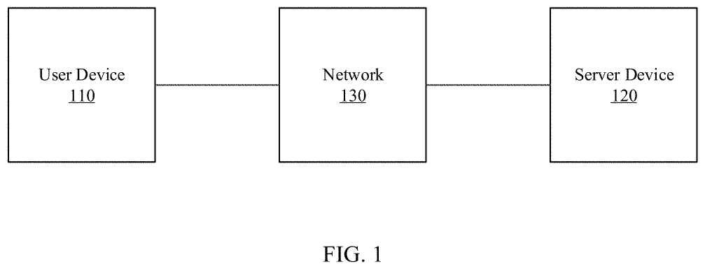

FIG. 1 is a diagram of devices of a system according to an embodiment. FIG. 1 includes a user device 110, a server device 120, and a network 130. The user device 110 and the server device 120 may interconnect via wired connections, wireless connections, or a combination of wired and wireless connections.

The user device 110 may include a computing device (e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device.

The server device 120 includes one or more devices. For example, the server device 120 may be a server device, a computing device, or the like.

The network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

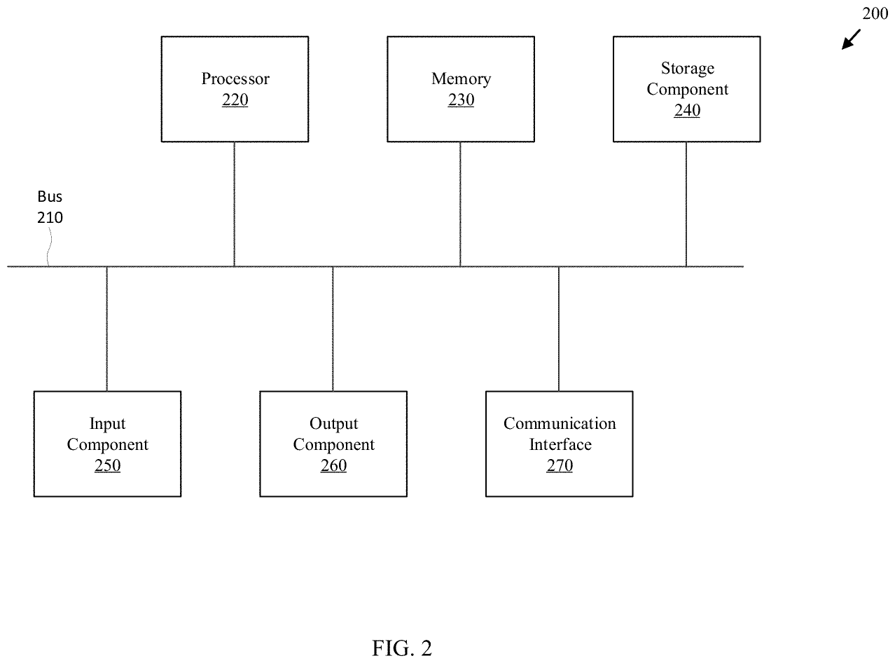

FIG. 2 is a diagram of components of one or more devices of FIG. 1 according to an embodiment. Device 200 may correspond to the user device 110 and/or the server device 120.

As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 220 includes one or more processors capable of being programmed to perform a function.

The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). The input component 250 may include a sensor for sensing information (e.g., a global positioning system (GPS) component, an accelerometer, a gyroscope, and/or an actuator).

The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

Machine learning (ML) models may train primarily through a process referred to as “gradient descent,” which operates as follows, assuming the correct labels for the training data are known. For each batch of data fed through the model during training, the system evaluates the output of the model using a “loss” function, which measures how wrong the model was at predicting the (known) labels of that data. A higher loss corresponds to a worse prediction. The loss function should be differentiable with respect to the parameters of the model. Therefore, when the system determines the gradient of that loss function, the direction in which the model parameters can be adjusted to either increase or decrease the loss is known. To decrease the loss, the system may take a small step for all model parameters in the direction of the negative gradient (hence the term “gradient descent”), proportional to the size of the gradient (e.g., a steeper gradient is a larger step, gradual gradient is a smaller step, etc.). The size of this proportionality factor is referred to as the learning rate. Once the model stops improving, the model has converged with a potential minimum of the loss function.

Overly low learning rates are undesirable, as the model may be unable to learn quickly enough to reach convergence in a reasonable time frame or may become stuck in a local minimum instead of continuing to a global minimum. Overly high learning rates are also undesirable, as they have a risk of overshooting the ideal model configuration and causing the loss of the model to approach infinity.

The optimal learning rate should balance the risks of a low learning rate and a high learning rate. The optimal learning rate may be high enough to allow the model to learn robustly, but not so high as to risk over-shooting. Therefore, selecting the appropriate learning rate is important to the final performance of a trained model.

The difference in the effect of two learning rates depends on the proportional distance between the learning rates, not on the absolute distance between the learning rates. For example, for a given gradient, a change in the step size from 0.001 to 0.002 is far more significant than a change from 0.101 to 0.102, even though the absolute change is the same. Thus, the system may utilize a logarithmic scale to evaluate learning rate changes, as this will allow equal proportional changes to be evenly spaced.

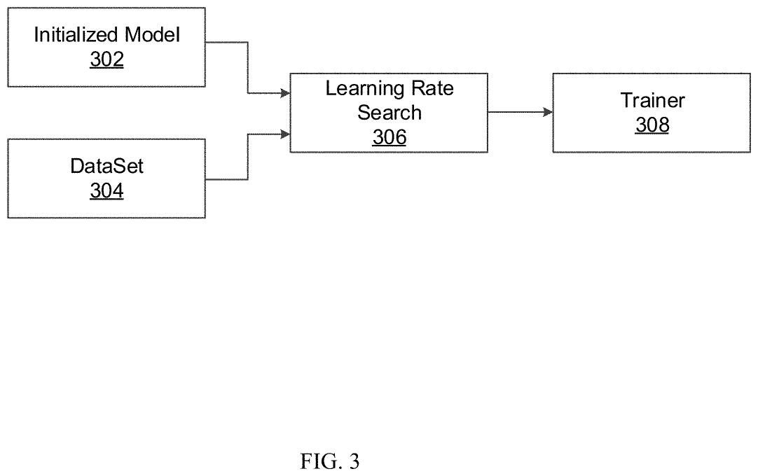

FIG. 3 is a diagram of a training pipeline, according to an embodiment. An initialized model 302 and a data set 304 are input into a learning rate search block 306. When the learning rate is selected, the parameters are sent to the trainer 308 for training the model. Thus, the optimal learning rate may be selected prior to training, such that the training process for the model will be as efficient as possible.

Selecting the learning rate is a tradeoff between not learning enough (i.e., the learning rate is too low) and overshooting the optimal values (i.e., the learning rate is too high). Thus, points where an increased learning rate is associated with improving learning potential are considered, and this is indicated by achieving a lower loss after a predetermined number of steps (i.e., n steps). The model and dataset between learning rate tests may be reset. Thus, the point selected may be the maximum viable learning rate (i.e., max_Ir). Any learning rates higher than max_Ir will have a loss that can be achieved with a lower learning rate, and are therefore non-optimal.

The lower end of learning rates may have slow improvement, until a critical point where increasing the learning rate begins to significantly improve the loss, which is referred to as a minimum viable learning rate (i.e., min_Ir). The min_Ir may be selected based on a point where the curvature of the loss/log(Ir) curve reaches its minimum, below a point at which half the curve's maximum loss reduction is reached, representing the learning rate where a significant improvement in loss for the first time occurs (i.e., the “knee” of the curve). The curvature k of curve y is defined as in Equation (1).

$$k = \frac{{y}^{n}}{{( 1 + {y}^{′2} )}^{\frac{3}{2}}} . \qquad ( 1 )$$

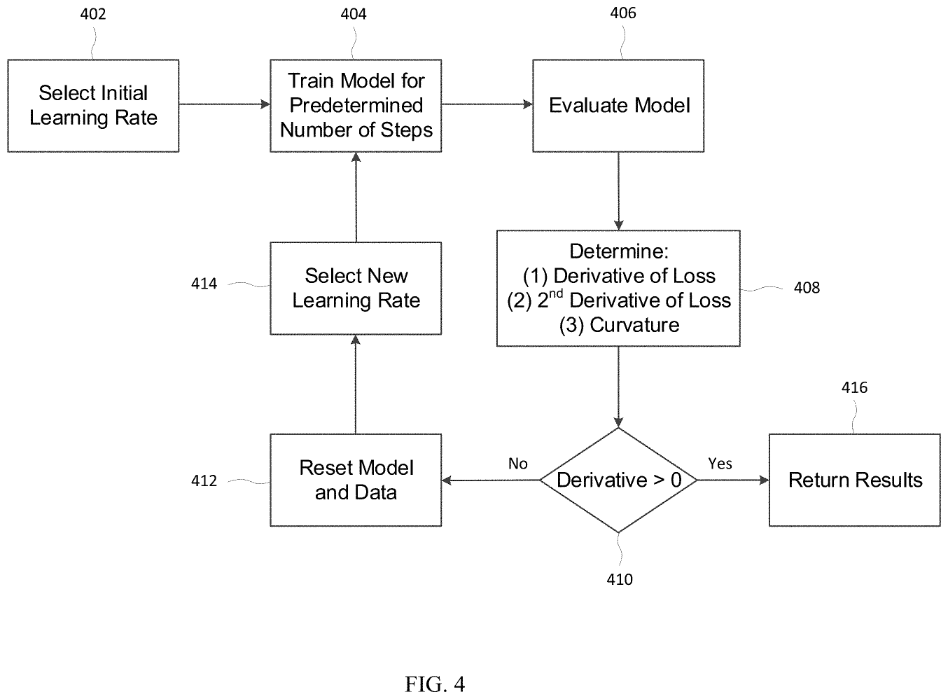

FIG. 4 is a flowchart of a method of a grid search process, according to an embodiment. In operation 402, the system selects an initial learning rate (e.g., 1e-8). In particular embodiments, the system also selects other training parameters, such as a step size and the number of training steps uses, as shown in Table 1. In operation 404, the system trains the model for a predetermined number of steps. In operation 406, the system evaluates the model. In operation 408, the system determines the derivative of the loss and, in particular embodiments, the second derivative of the loss and the curvature (e.g., result of Equation (1)). In operation 410, the system determines whether the derivative of the loss is greater than 0. Based on the system determining that the derivative of the loss is not greater than 0 (e.g., less than or equal to 0), in operation 412, the system resets the model and the data. In operation 414, the system selects a new learning rate. Then, the system repeats operations 404, 406, 408 and 410. In operation 410, based on the system determining that the derivative of the loss is greater than 0, in operation 416, the system returns the results (e.g., a set of tested learning rates and corresponding losses from both the broad grid search and the subsequent refinement steps).

An example embodiment of the grid search process is provided in Table 1.

```
TABLE 1
Select the following:
  An initial learning rate value lr_start (for example, 1e-8)
  A broad step size r (5 for example, for a half order of magnitude step)
  The number of steps to train at each learning rate, b (for example, 20).
  Initialize the step n, the learning rate lr, and the
derivative of the loss d_loss all to 0
Then enter a loop:
While (d_loss <= 0): (once d_loss is greater than 0, the loss is
increasing and the process may stop)
      a) Reset the model weights to their initial value and
        reset the dataset to batch 0.
      b) Train the model for b steps
      c) Evaluate the model with the validation set, and record
        loss_i, the loss achieved on the validation set.
      d) Calculate and save:
          I.  d_loss = change in loss from previous step/change
              in log(lr) from the previous learning rate.
          II.  dd_loss = change in djoss from previous step/change
              in log(lr) from the previous learning rate.
          III.  curvature = result of Equation (1)
Select a new learning rate using lr = lr_start * r\hat{ }n, and increment n
```

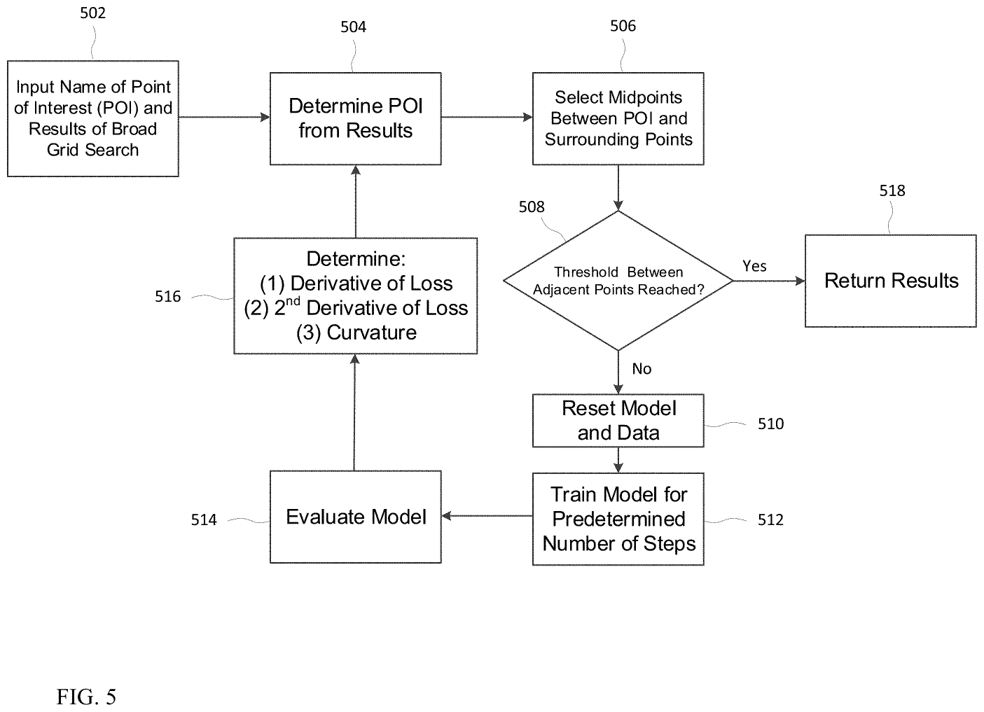

FIG. 5 is a flowchart of a method of a refinement process, according to an embodiment. In operation 502, the system inputs a name of a point of interest (POI) to be calculated in the refinement process and the results (e.g., the set of learning rates and corresponding losses from the broad grid search and a subsequently completed refinement process) from the broad grid search (e.g., the grid search of FIG. 4). In operation 504, the system determines the POI from the input results. Various POIs are defined and may be utilized in various embodiments, as shown in Table 2.

TABLE 2

| POI | Definition |
|---|---|
| max_lr | The maximum learning rate of the viable learning rate window, |
| | defined by the learning rate that achieves the minimum loss. |
| half_min_loss_lr | The learning rate that achieves a loss halfway between the loss |
| | achieved by a learning rate of 0, and the loss achieved by |
| | “max_lr”. |
| min_lr | The minimum learning rate of the viable learning rate window, |
| | defined by the learning rate below “half_min_loss_lr” with the |
| | minimum curvature of loss. |
| min_d_loss | The learning rate with the lowest derivative, below “max_lr”. |

In operation 506, the system selects midpoints (i.e., selecting learning rates) between the POI and surrounding points. For example, the system may select a learning rate on either side of each POI approximately halfway on a logarithmic scale between a first POI and a next tested learning rate (the tested learning rate points may or may not be POIs based on various embodiments). If the POI lies between two tested learning rates, the system may select a point approximately halfway between the two tested learning rates.

In operation 508, the system determines whether a threshold between adjacent points has been reached. For example, the threshold may specify the minimum difference between the closest two tested points and/or the minimum distance between the calculated POI and the closest tested learning rates on each side. Based on the threshold between adjacent points not being reached (i.e., that the difference between the closest two tested points is greater than the threshold or that the difference between the calculated POI and the closest tested learning rates on each side is greater than the threshold), then for each of the learning rates selected in step 506, the system performs operations 510-516. In operation 510, the system resets the model and data. In operation 512, the system trains the model for a predetermined number of steps, using the selected learning rate. In operation 514, the system evaluates the model. In operation 516, the system determines the derivative of the loss and, in particular embodiments, the second derivative of the loss, and the curvature (e.g., result of Equation (1)). Operations 510, 512, 514 and 516 may correspond to steps a, b, c, and d of Table 1, respectively. The system then repeats operations 504, 506 and 508. In operation 508, based on the threshold between adjacent points being reached (i.e., that the difference between the closest two tested points is greater than the threshold), in operation 518, the system returns the results (e.g., the provided set of learning rates and corresponding losses, with newly tested learning rates and corresponding losses appended).

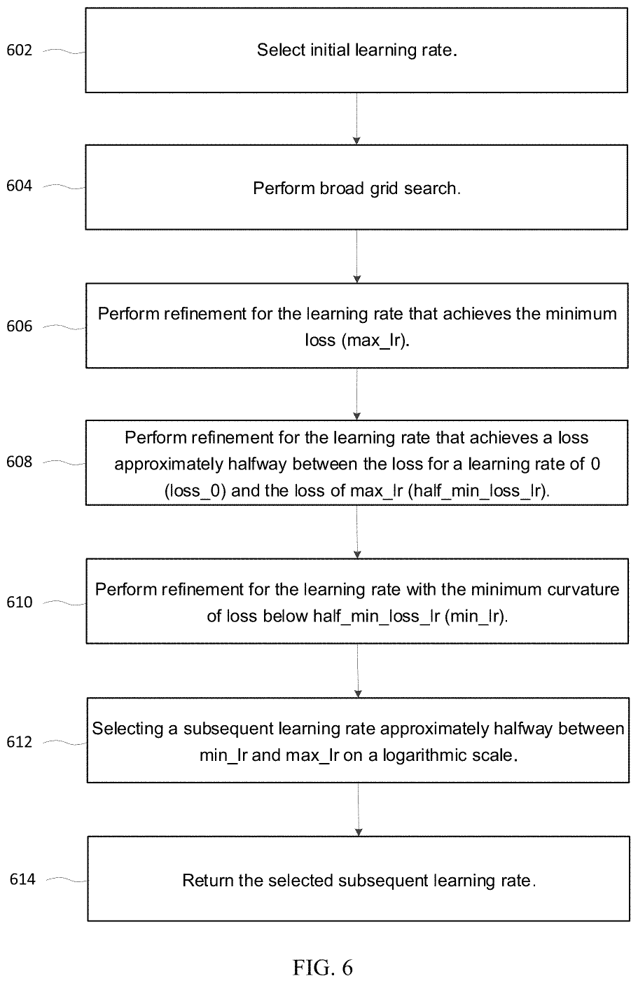

FIG. 6 is a flowchart of a method of selecting a learning rate, according to an embodiment. In operation 602, the system selects an initial learning rate. In operation 604, the system performs a broad grid search (e.g., the grid search of FIG. 4). In operation 606, the system performs refinement for the learning rate that achieves the minimum loss (max_Ir). For example, the system may perform the refinement process described in FIG. 5 using the max_Ir as the input POI. In operation 608, the system performs refinement for the learning rate that achieves a loss approximately halfway between the loss for a learning rate of 0 (loss_0) and the loss of max_Ir (half_min_loss_Ir). In operation 610, the system performs refinement for the learning rate with the minimum curvature of loss below half_min_loss_Ir (min_Ir). Using half min_loss_Ir as an upper bound for min_Ir keeps fluctuations of the curvature in check, while allowing for some movement in the curvature prior to min_Ir. min_Ir may be the lower limit of the viable window (i.e., learning rates below this point learn very slowly, and risk becoming stuck in a local minimum). In operation 612, the system selects a subsequent learning rate approximately halfway between min_Ir and max_Ir on a logarithmic scale. In operation 614, the system returns the selected subsequent learning rate.

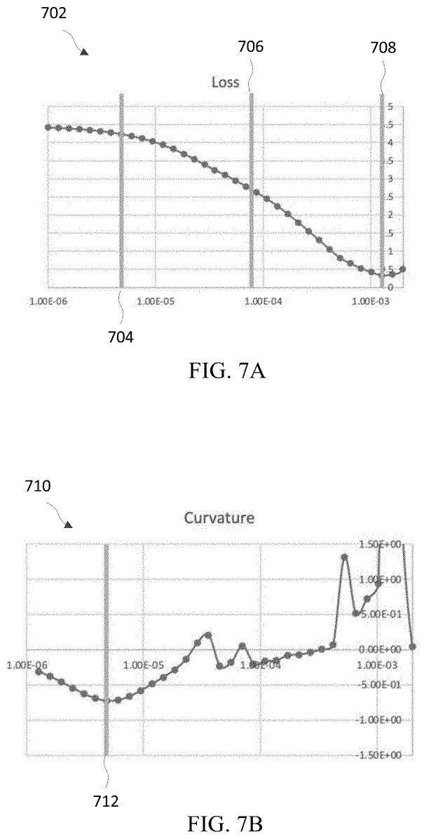

FIGS. 7A and 7B are graphs showing selection of a learning rate, according to an embodiment. Graph 702 depicts loss, while graph 710 depicts curvature. In graph 702, the point along line 704 corresponds to min_Ir, the point along line 706 corresponds to the final selected learning rate for this embodiment, which is half-way between min_Ir and max_Ir, and the point along line 708 corresponds to max_Ir. In graph 710, the point along line 712 corresponds to the learning rate with the minimum curvature of loss below half min_loss_Ir.

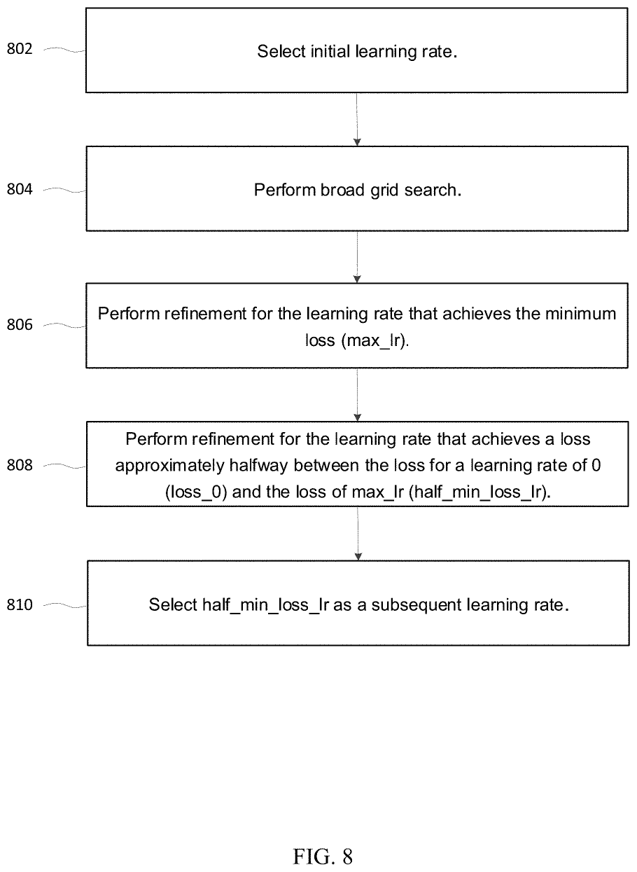

FIG. 8 is a flowchart of a method of selecting a learning rate, according to an embodiment. In operation 802, the system selects an initial learning rate. In operation 804, the system performs a broad grid search (e.g., the grid search of FIG. 4). In operation 806, the system performs refinement for the learning rate that achieves the minimum loss (max_Ir). For example, the system may perform the refinement process described in FIG. 5 using the max_Ir as the input POI. In operation 808, the system performs refinement for the learning rate that achieves a loss approximately halfway between the loss for a learning rate of 0 (loss_0) and the loss of max_Ir (half_min_loss_Ir). In operation 810, the system selects half min_loss_Ir as a subsequent learning rate.

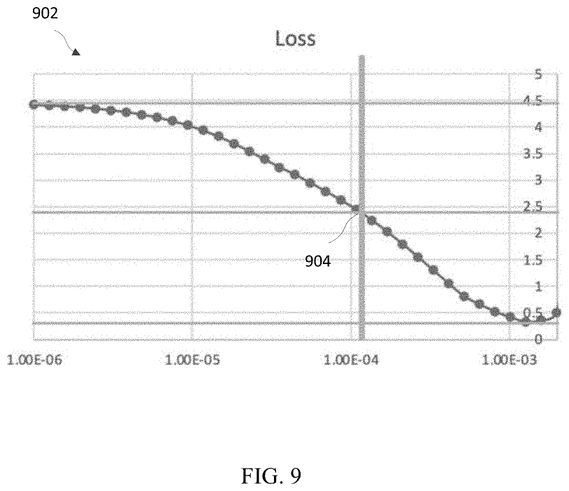

FIG. 9 is a graph showing selection of a learning rate, according to an embodiment. Graph 902 depicts loss. Point 904 is the first point at which half of the maximum reduction in loss is achieved (e.g., half_min_loss_Ir).

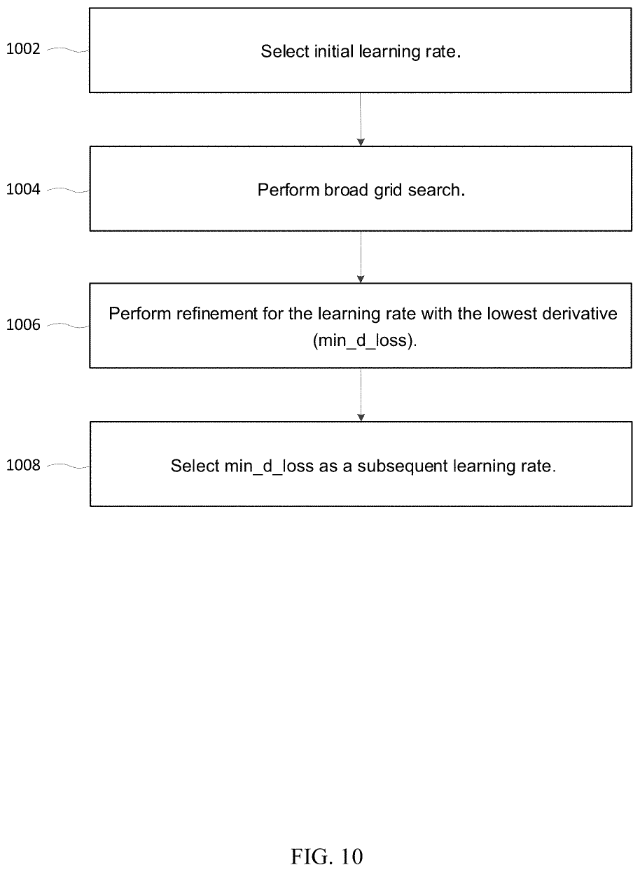

FIG. 10 is a flowchart of a method of selecting a learning rate, according to an embodiment. In operation 1002, the system selects an initial learning rate. In operation 1004, the system performs a broad grid search (e.g., the grid search of FIG. 4). In operation 1006, the system performs refinement for the learning rate with the lowest derivative (min_d_loss). For example, the system may perform the refinement process described in FIG. 5 using the min_d_loss as the input POI. In operation 1008, the system selects min_d_loss as a subsequent learning rate.

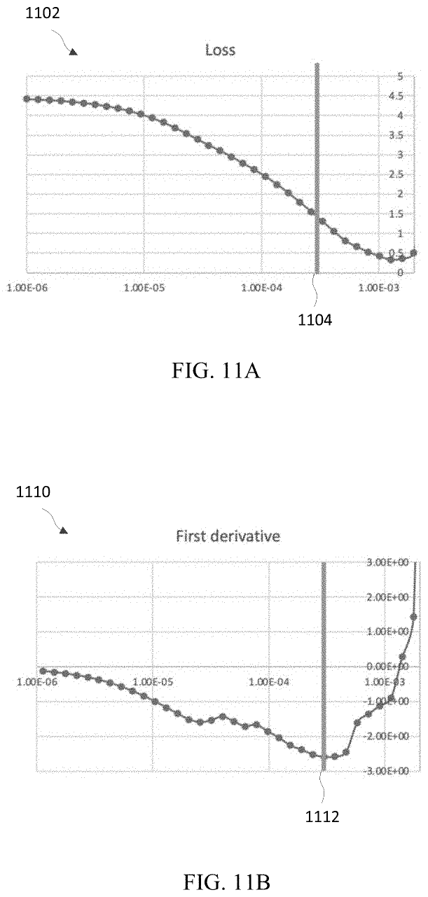

FIGS. 11A and 11B are graphs showing selection of a learning rate, according to an embodiment. Graph 1102 depicts loss, and graph 1110 depicts first derivatives. The point along line 1112 corresponds to the point where the first minimum of the derivative of the loss curve of graph 1102 occurs, and the point along line 1104 corresponds to min_d_loss.

While this disclosure describes example methods of selecting a learning rate using the steps of FIGS. 4-5, such as the example methods of FIGS. 6, 8, and 10, this disclosure contemplates that other methods may be used. Moreover, this disclosure contemplates that a learning rate may be selected after implementing multiple approaches. For example, each of the example methods of FIGS. 6, 8, and 10 may be run, and then the best resulting learning rate may be selected from the set of optimal learning rates returned by those methods.

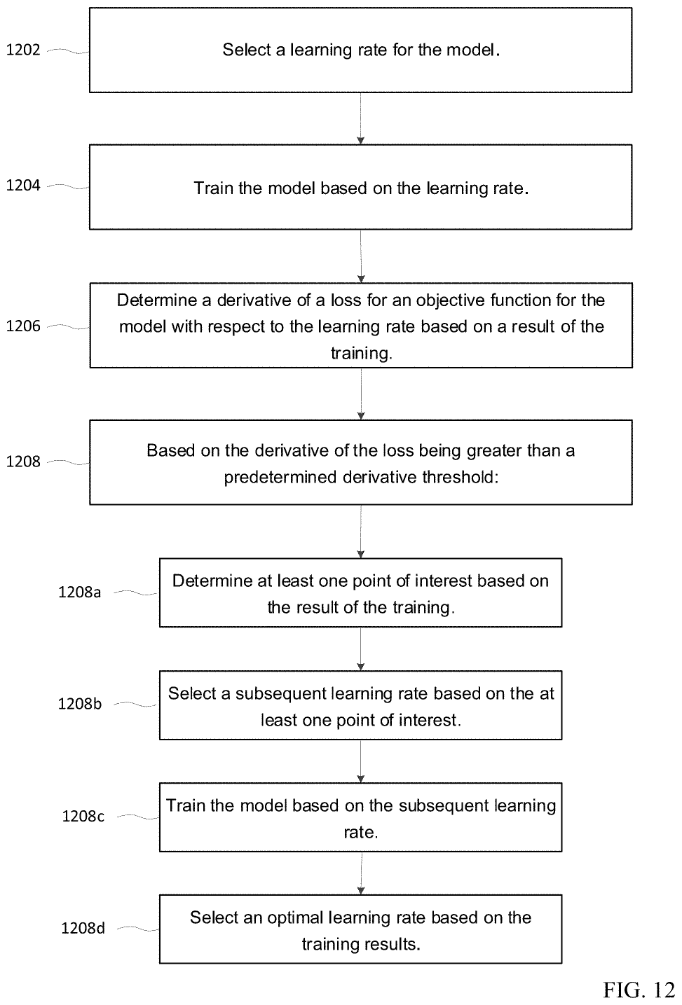

FIG. 12 is a flowchart of a method of selecting a learning rate, according to an embodiment. In operation 1202, the system selects a learning rate for the model. In operation 1204, the system trains the model based on the learning rate. In operation 1206, the system determines a derivative of a loss for an objective function for the model with respect to the learning rate based on a result of the training. In operation 1208, based on the derivative of the loss being greater than a predetermined derivative threshold, the system performs operations 1208a, 1208b, 1208c, and 1208d. In operation 1208a, the system determines at least one point of interest based on the result of the training. In operation 1208b, the system selects a subsequent learning rate based on the at least one point of interest. In operation 1208c, the system trains the model based on the subsequent learning rate. In operation 1208d, the system selects an optimal learning rate based on the training results.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training a model, the method comprising:
selecting a learning rate for the model;
training the model based on the learning rate;
determining a derivative of a loss for an objective function for the model with respect to the learning rate based on a result of the training; and
based on the derivative of the loss being greater than a predetermined derivative threshold:
determining at least one point of interest based on the result of the training;
selecting a subsequent learning rate based on the at least one point of interest;
training the model based on the subsequent learning rate; and
selecting an optimal learning rate based on the training results.

2. The method of claim 1, further comprising repeating the determining the at least one point of interest and the selecting the subsequent learning rate until a difference between the subsequent learning rate and a learning rate closest to the subsequent learning rate is less than a minimum difference threshold.

3. The method of claim 1, wherein determining at least one point of interest comprises:
determining a first learning rate where a minimum loss is achieved; and
determining a second learning rate that achieves a loss approximately halfway between a loss for a learning rate of zero and a loss at the first learning rate.

4. The method of claim 3, wherein determining at least one point of interest further comprises determining a third learning rate with a minimum curvature less than the second learning rate, and
wherein selecting the subsequent learning rate comprises selecting a fourth learning rate as the subsequent learning rate that is approximately halfway between the third learning rate and the first learning rate.

5. The method of claim 4, wherein the fourth learning rate is approximately halfway between the third learning rate and the first learning rate on a logarithmic scale.

6. The method of claim 3, wherein selecting the subsequent learning rate comprises selecting the second learning rate as the subsequent learning rate.

7. The method of claim 1, further comprising, based on the derivative of the loss being less than or equal to the predetermined derivative threshold:
selecting an updated learning rate, training the model based on the updated learning rate, and determining the derivative of the loss for the objective function for the model based on the updated learning rate based on a result of the training, until the derivative of the loss is greater than the predetermined derivative threshold.

8. A system for training a model, the system comprising:
a processor; and
a memory storing instructions that, when executed, cause the processor to:
select an initial learning rate for the model;
train the model based on the initial learning rate;
determine a derivative of a loss of the initial learning rate based on a result of the training; and
based on the derivative of the loss being greater than a predetermined derivative threshold:
determine at least one point of interest based on the result of the training;
select a subsequent learning rate based on the at least one point of interest; and
train the model based on the subsequent learning rate.

9. The system of claim 8, wherein the instructions, when executed, further cause the processor to repeat the determining the at least one point of interest, the selecting the subsequent learning rate, and the training the model based on the subsequent learning rate) until a difference between learning rates is less than a minimum difference threshold.

10. The system of claim 8, wherein the instructions, when executed, further cause the processor to determine at least one point of interest by:
determining a first learning rate where a minimum loss is achieved; and
determining a second learning rate that achieves a loss approximately halfway between a loss for a learning rate of zero and a loss at the first learning rate.

11. The system of claim 10, wherein the instructions, when executed, further cause the processor to determine at least one point of interest further by determining a third learning rate with a minimum curvature less than the second learning rate, and
wherein the instructions, when executed, further cause the processor to select the subsequent learning rate by selecting a fourth learning rate as the subsequent learning rate that is approximately halfway between the third learning rate and the first learning rate.

12. The system of claim 11, wherein the fourth learning rate is approximately halfway between the third learning rate and the first learning rate on a logarithmic scale.

13. The system of claim 10, wherein the instructions, when executed, further cause the processor to select the subsequent learning rate by selecting the second learning rate as the subsequent learning rate.

14. The system of claim 8, wherein the instructions, when executed, further cause the processor to determine at least one point of interest by determining a fifth learning rate where the derivative of the loss of the initial learning rate reaches a minimum, and
wherein the instructions, when executed, further cause the processor to select the subsequent learning rate by selecting the fifth learning rate as the subsequent learning rate.

15. A non-transitory computer-readable storage medium comprising instructions that, when executed, cause at least one processor to:
select an initial learning rate for the model;
train a model based on the initial learning rate;
determine a derivative of a loss of the initial learning rate based on a result of the training; and
based on the derivative of the loss being greater than a predetermined derivative threshold:
determine at least one point of interest based on the result of the training;
select a subsequent learning rate based on the at least one point of interest; and
train the model based on the subsequent learning rate.

16. The storage medium of claim 15, wherein the instructions, when executed, further cause the at least one processor to repeat the determining the at least one point of interest, the selecting the subsequent learning rate, and the training the model based on the subsequent learning rate until a difference between learning rates is less than a minimum difference threshold.

17. The storage medium of claim 15, wherein the instructions, when executed, further cause the at least one processor to determine at least one point of interest by:
determining a first learning rate where a minimum loss is achieved; and
determining a second learning rate that achieves a loss approximately halfway between a loss for a learning rate of zero and a loss at the first learning rate.

18. The storage medium of claim 17, wherein the instructions, when executed, further cause the at least one processor to determine at least one point of interest further by determining a third learning rate with a minimum curvature less than the second learning rate, and
wherein the instructions, when executed, further cause the at least one processor to select the subsequent learning rate by selecting a fourth learning rate as the subsequent learning rate that is approximately halfway between the third learning rate and the first learning rate.

19. The storage medium of claim 17, wherein the instructions, when executed, further cause the at least one processor to select the subsequent learning rate by selecting the second learning rate as the subsequent learning rate.

20. The storage medium of claim 15, wherein the instructions, when executed, further cause the at least one processor to determine at least one point of interest by determining a fifth learning rate where the derivative of the loss of the initial learning rate reaches a minimum, and
wherein the instructions, when executed, further cause the at least one processor to select the subsequent learning rate by selecting the fifth learning rate as the subsequent learning rate.
